(19) United States
(12) Patent Application Publication
(10) Pub. No.: US 2008/0012297 A1
(43) Pub. Date: Jan. 17, 2008

(54) Flexible pipe element

(75) Inventors: Bernhard Heil, Langensteinbach (DE); Gebhard Saur, Birkenfeld (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Witzenmann GmbH, Pforzheim (DE)

(21) Appl. No.: 10/546,103

(22) PCT Filed: Feb. 19, 2004
(86) PCT No.: PCT/EP04/01608

§ 371 Date: Jan. 31, 2006

(30) Foreign Application Priority Data
Feb. 19, 2003 (DE) 203 02 657.8

(51) Int. Cl. F16L 51/02

(52) U.S. Cl. 285/226

(57) ABSTRACT

A flexible pipe element, in particular for the exhaust gas system of a motor vehicle is provided. The pipe element includes a metal bellows (1), with a thread-like or annular corrugated construction, and a metal hose (3), which is positioned coaxially within the metal bellows (1), and is formed of segments that are annular or wound in the manner of a thread. The external cross section of the hose is smaller than the interal cross section of the metal bellows. At least one spacer (4) is arranged between the metal bellows (1) and the metal hose (3). The metal hose (3) is configured in such a way that at least in a compressed position of the metal hose (3), the individual wound sections or the individual annular segments that do not have a radial form-fit with a respective adjacent one of the wound sections or segments.

The invention relates to a flexible pipe element, in particular, for the exhaust-gas system of a motor vehicle. The pipe element comprises metal bellows, which have a threaded or annular corrugated construction, and a metal hose, which is positioned coaxially inside the metal bellows and includes segments that are annular or are wound in the manner of a thread. The external cross section of said hose is smaller than the internal cross section of the metal bellows, and at least one spacer is positioned between the metal bellows and the metal hose.

Such flexible pipe elements are used in the exhaust-gas pipes of motor vehicles in order, on one hand, to uncouple changing load movements and forces on the engine from poor road surfaces from the exhaust-gas system mounted on the underbody of the vehicle and also, on the other hand, to decouple engine vibrations due to non-compensated free forces of gravity from the exhaust-gas system and thus from the underbody of the vehicle. The latter prevents vibrations and droning noises from being led into the vehicle interior; in addition, this increases the service life of the exhaust-gas system, which can otherwise be negatively affected by resonance vibrations.

Flexible pipe elements of the above-noted type are known, for example, from DE 297 07 908 U1 by the applicant or from WO02/29302 A1. The pipe elements described in these publications essentially comprise a metal bellows, which is surrounded on the outside with a wire mesh, and also a metal hose, which is positioned coaxially inside the bellows and which consists of double-lock profiles with S-shaped cross sections. The double-lock hose is used primarily for flow guidance and for thermal protection of the metal bellows from the hot exhaust gases of the internal-combustion engine. Because the metal bellows guarantees the gas tightness of the flexible pipe element and is essentially also responsible for its mechanical stability, no special requirements on stability or gas tightness are to be placed on the double-lock hose. Thus, it is generally formed with a correspondingly thin wall.

To guarantee decoupling characteristics both for high-frequency vibrations and also for low-frequency vibrations, without requiring too large of an installation space, it is advantageous to keep the stiffness of a flexible pipe element named above as low as possible.

The profiles of a double-lock hose comprise an essentially radially extending middle section, whose two ends are connected to axially extending sections, which extend in opposing axial directions. Radially extending sections connect to the ends of these axially extending sections. Here, the radially extending section of the radially inner axial section points outwards and the radially extending section of the radially outer axial section points inwards. Another axially extending section, which extends in the direction of the middle radial section, is positioned on each of the free ends of the radial sections. This leads to hooking of adjacent segments or wound sections, whereby the hose obtains its large intrinsic stability. The form-fit created between the adjacent segments or wound sections imparts to the hose, in addition to high strength under tensile, bending, and lateral loads, primarily also under twisting loads, a very large stability. Changes in diameter of the hose due to a torsion-dependent rotation is prevented due to the radial form-fit and unhooking of adjacent segments or wound sections is effectively prevented.

Therefore, a disadvantage in double-lock hoses is the complicated and cost-intensive production, because it requires complicated tools and machines, whose production speed is low due to the tightly followed tolerances, for forming this complex interlocked geometry. In addition, there is a large use of material, because four material layers overlap in the radial direction at least partially. The four overlapping material layers also require a large radial expansion of the double-lock profile, whereby for the given outer diameter, a relatively small inner diameter is produced, which disadvantageously affects the flow and particularly the resulting pressure loss. Or in other words, for a given inner diameter, the double-lock hose requires a relatively large amount of installation space in the radial direction, which has a negative effect on the packaging in the vehicle.

It is further disadvantageous that the movement of the hose is limited by the axially extending sections of the double-lock profile, which overlap in each layer of the hose for achieving the necessary intrinsic stability. For given equalizing motion, this leads to long decoupling elements, in the axial direction, which require an unnecessarily large installation space and are also correspondingly expensive and heavy due to the large use of material. Furthermore, it is also disadvantageous for this shape of the wound section hose that it produces friction, which increases the stiffness of the hose and reduces the decoupling effect, due to contact of axially adjacent, interlocking wound sections.

Therefore, the invention is based on the objective of improving a flexible pipe element of the above-noted type such that its movement can be increased or a certain movement can also be achieved with shorter components.

This problem is solved by a flexible pipe element with the features of the enclosed Claim 1. Advantageous configurations and improvements of the pipe element according to the invention are listed in Claims 2 to 23.

Thus, in addition to the features named above, the flexible pipe element according to the invention is distinguished by the special construction of the metal hose: this is configured so that the individual wound sections or the individual annular segments have no form-fit with the respective adjacent wound section or segment at least in the compressed position in the radial direction.

This is a radical rejection of the concept of the double-lock hose. This is because in double-lock hoses, their profile edges are bent back inwards such that they form axial rims, which overlap radially with the axial rim of the respective adjacent segment or wound section even in the compressed position. Especially for wound double-lock hoses, the wound sections were otherwise unlocked by torsional loading of the hose and the intrinsic stability of the hose was lost.

According to the invention, it has now been recognized that the rim length of these bent-back profile edges of a conventional double-lock hose limits the axial movement of the metal hose; this is because the drawing length of the double-lock hose is reduced for each wound section or segment by a corresponding rim length of the profile edges. Furthermore, according to the invention it has been recognized that the production of such a hooked profile is expensive, because tight tolerances must be followed in order to obtain a functional hose, and the production of this complex geometry requires complicated tools and machines. It has also been recognized that the resistance in the double-lock hose against torsional loading is not important in the given relationship of the present flexible pipe element, because the metal bellows are resistant to torsion. Additionally, the hose is supported in the decoupling element according to the invention in the radial direction by a spacer, at least locally, against the bellows, so that, for this reason, the radial form-fit between the adjacent windows or segments can be eliminated. In addition, noise emissions, which are caused by a hose hitting the bellows, are effectively prevented by the spacer. Thus, the radial overlapping, which can include a form-fit of the individual metal hose segments or wound sections relative to each other in the compressed position, can be eliminated. In this way, the path for axial movements becomes longer, which also has a positive effect on lateral movements and also on the minimum bending radius. In addition, the friction between the individual segments or wound sections is reduced, which also advantageously increases the flexibility of the metal hose and thus the entire pipe element. The present spacer, which can definitely be dimensioned so that it delivers no significant contribution to the damping behavior of the pipe element, guarantees that only small requirements have to be placed on the intrinsic stability of the metal hose that is used.

The spacer can be fixed on the bellows or on the hose at least locally by a positive fit, form-fit, or non-positive fit or else attached loosely. Here, the spacer does not have to have a constant thickness in the circumferential direction. Instead, the spacer can have a strip-like, helical, or any other form of construction. It is important only that at least one point of the gap between the bellows and the wound section hose is filled so that the hose is prevented from hitting the bellows.

In a preferred configuration, the cross section of the hose is round, but other cross-sectional forms, such as polygonal, oval, or any other form are also conceivable.

Therefore, there are many different possibilities for reducing the invention to practice. It is important only that the optional form-fit overlapping of hook-shaped bent edges of the wound section or segment profile does not remain in the radial form-fit when the metal hose is compressed, i.e., two axially adjacent ring systems or wound sections with a corresponding position in the circumferential direction can be arbitrarily enlarged in the radial direction, without coming into contact with the adjacent ring system or wound section. In a preferred configuration, the hose is wound from one band, but two or more bands can also be wound into one hose. If several bands are processed into one hose, then these need not be manufactured from the same material. Instead, there is the possibility of combining various materials or surfaces to each other, which can improve, in particular, the tribology of the hose.

In a known way, the spacer can be formed of a woven material, a knitted material, mesh, or a non-woven material and, as likewise already known, can be formed either as a hose, a hose section, a coil, or as a plurality of strips. The type of production and the shaping of the spacer essentially depend on which damping properties are to be achieved or prevented.

The spacer is preferably positioned using a means and method that radially fixes the metal hose inside the metal bellows. This means that the spacer at least locally completely fills the radial space between the metal hose and the metal bellows in the radial direction, so that at this point the metal hose has no play relative to the metal bellows. In this way, any noise development is prevented, especially due to stimulation of the metal bellows or the metal hose at its resonant frequency.

In turn, in a known way, the metal bellows of the flexible pipe element according to the invention can be surrounded on the outside by at least one component, for example, by a mesh and/or a knitted material. In addition to a possibly desired damping effect, this outer sleeve protects the metal bellows from mechanical damage and also offers limitation against too much lengthening of the metal bellows. This mesh and/or knitted material is preferably arranged so tightly around the metal bellows that here there is also no risk of noise development due to components hitting each other or due to resonant vibrations. The bellows can also be surrounded by several components, for example, a mesh and a knitted material, several meshes or several knitted materials. In this way, these do not absolutely have to cover the entire length of the bellows, instead it is also conceivable that only a portion of the bellows is surrounded by these components. It is also not absolutely necessary to fix the knitted materials or meshes surrounding the bellows so that they cannot move axially on the bellows.

With regard to the shape of the bellows, it can have corrugations with a constant outer diameter over its entire length. However, preferably one or more end corrugations can have a smaller outer diameter. If several end corrugations have a reduced outer diameter, then in a preferred configuration, the outer diameter of these corrugations falls constantly from the last corrugation with a “normal” diameter up to the end corrugation. In this way, the bending loads acting on the end corrugations through the deflection of a coating, which surrounds the bellows and which comprises, for example, a mesh or knitted material made from metal in a preferred configuration, are reduced and the corrugation is simultaneously stabilized. In another configuration of the bellows, it can have a non-corrugated middle region, which leads to savings in terms of material, weight, and costs for predominantly lateral loading. The stability of the end corrugation against the bending loads resulting from a present coating can also be increased such that the corrugation length of this corrugation is increased, which produces a better support. This can also be combined with a smaller outer diameter of the end corrugation.

In a known way, the bellows can be made from one or more layers, wherein several layers are definitely preferred due to the better resistance to wear.

The cross section of the bellows is round in a preferred configuration, but other cross-sectional shapes are also possible; thus, for example, for limited installation space in a plane, an oval bellows cross section can definitely also be useful.

The metal hose can be formed from wound sections or segments with a hook-shaped profile, wherein hook-shaped profile edges are present, which do not mutually overlap in the radial direction at least in the compressed position of the metal hose. Such a hook shape provides a certain stability close to that of the double-lock profile, wherein, however, nevertheless the movement of the metal hose is significantly increased compared with a double-lock hose due to the lack of mutual overlapping in the compressed position. For the hook shape of the profile edges, there are few handicaps: the greater the radial overlap in the extended state of the metal hose, the higher the stability and strength, while simultaneously the movement decreases.

A preferable compromise is a profile, which is formed from an inner and an outer axial section, a radial section connecting these axial sections, and also an edge that is bent away essentially radially from the axial sections. The axial movement is doubled compared with a double-lock hose, while nonetheless effective tensile protection and also relatively high insulating effect between the gas flow and the metal bellows is created.

The edge bent away from the axial sections do not have to always run radially; instead they can also be bent backward or bent away at a smaller angle than 90°. In each case, it is preferable when the edges have a smaller radial extent than the radial section of the profile. This is because rubbing of the edges on the axial sections is prevented or significantly reduced, which in turn benefits the movement of the metal hose.

If an especially high movement of the metal hose is desired, the profile can also be embodied so that it essentially comprises an inner and an outer axial section and also a connecting section joining these axial sections, thus so that the hook-shaped bent-away profile edges are completely eliminated. This variant has absolutely no limit to the movement in the tensile direction, however, because its bellows is surrounded by a mesh or knitted material in the pipe elements according to the invention, the bellows is already protected from an excess tensile load just by this mesh or knitted material, there is not a need to install a hose with a movement limit in the tensile direction.

It has proven to be favorable to wind the metal hose in the manner of a thread and to shape the wound section profile, such that a ratio of the lead in the extended state to the lead in the compressed state is greater than 1.39. This is a ratio that could not have been achieved at all by previous conventional double-lock hoses due to their construction.

Other special advantages result in the scope of the invention when the flexible pipe element is provided on at least one of its two ends with an adapter piece, which has an outer pipe section for placement of a cylindrical end of the metal bellows and also an inner pipe section for placement of the metal hose end. Through such an adapter piece, the inner metal hose can be connected in a very simple way without the need for expansion to the normally present cylindrical ends of the metal bellows and thus can be fixed to these ends. Simultaneously, the adapter piece can be provided with devices, which simplify the mounting in the exhaust-gas pipe of the motor vehicle or enable detachable mounting, for example, by means of a flange connection. In addition, the adapter piece can also take over the function of an adapter and thus simplify the combination of metal hoses and metal bellows with different diameters. Here, the hose can be connected to the adapter piece with a positive fit, form-fit, or non-positive fit. For example, the hose and the adapter piece can be fixed to each other by means of a weld connection, but the adapter piece can also be provided with a thread-like bulge, which engages in the intermediate spaces of the individual hose wound sections and thus produces a form-fit. The adapter piece can be attached both on the radial outer side and also on the radial inner side of the hose.

Obviously, the hose end can also be connected directly, thus without an adapter piece, to the rim of the bellows. This can be realized both by means of a positive fit, for example, by means of a weld connection, a form-fit, for example, by means of a bead inserted into the hose and bellows, and also a non-positive fit, for example, by pressing. Combinations, for example, pressing and weld points, are also conceivable.

Exemplary embodiments of the pipe element according to the invention are described and explained in more detail below with reference to the enclosed drawings. Shown are:

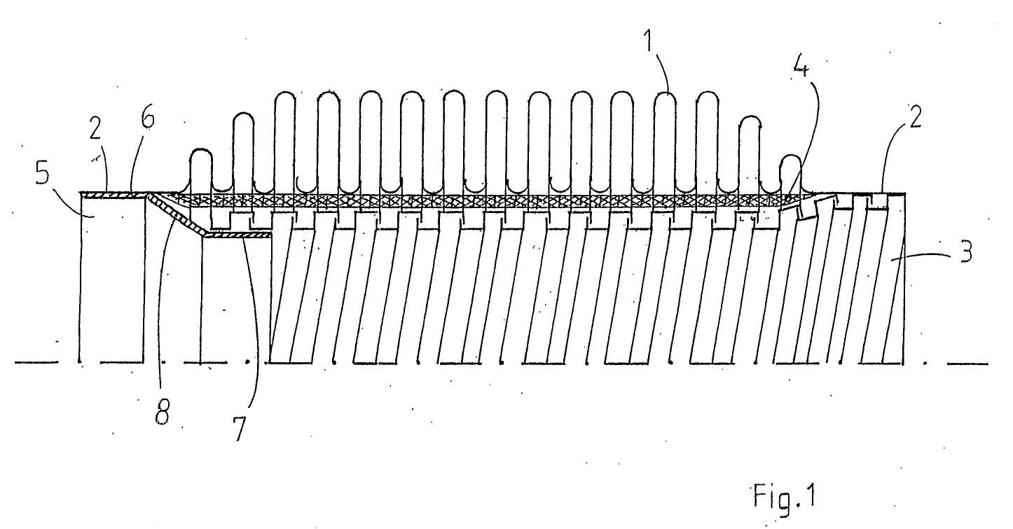

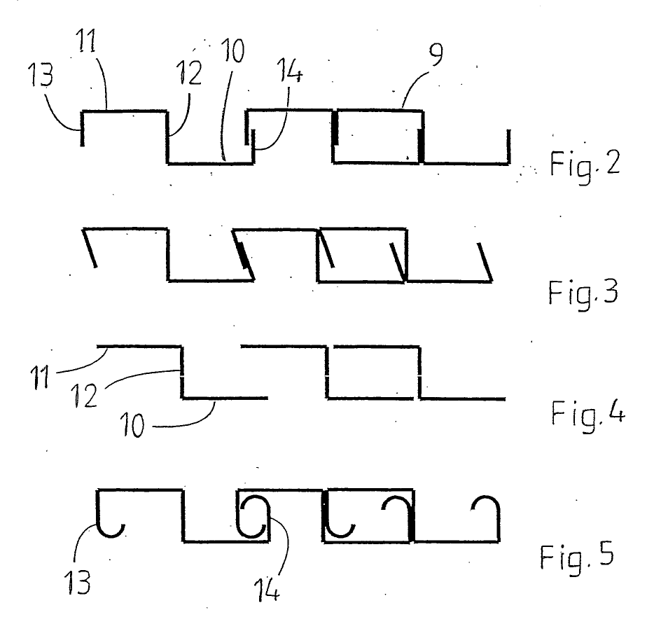

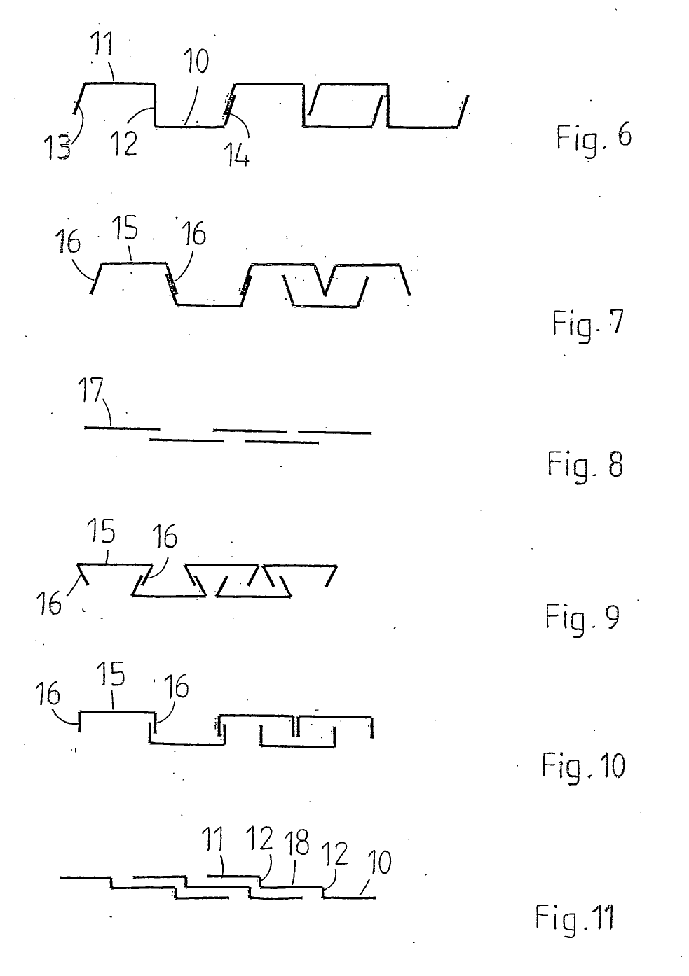

FIG. 1 a schematic section through a flexible pipe element according to the invention;

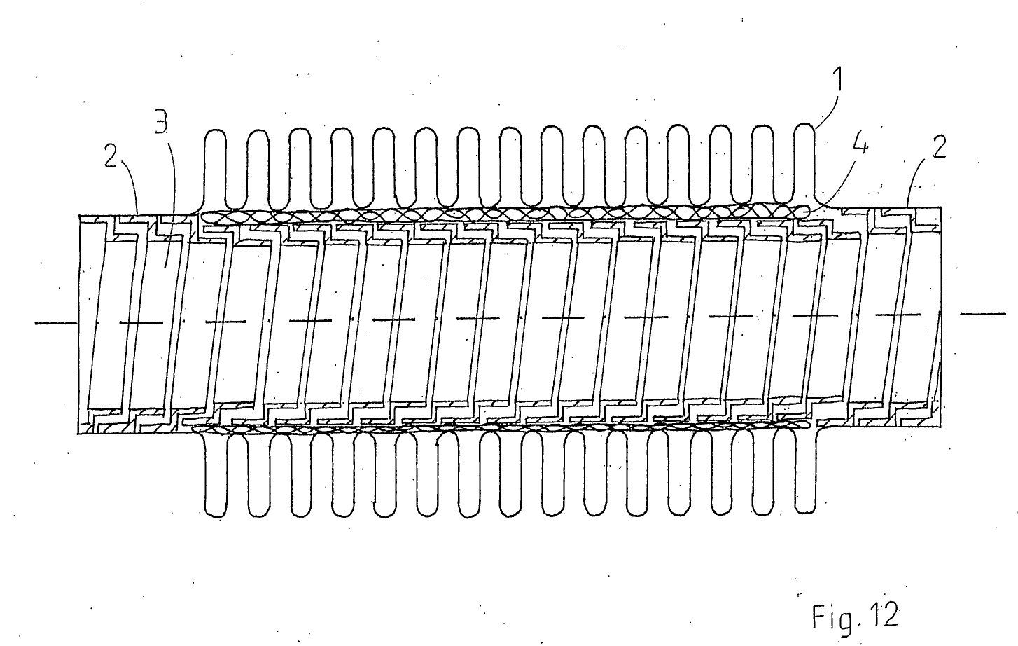

FIGS. 2 to 11 a few examples for cross-sectional shapes of the metal hose wound sections or metal hose segments; and

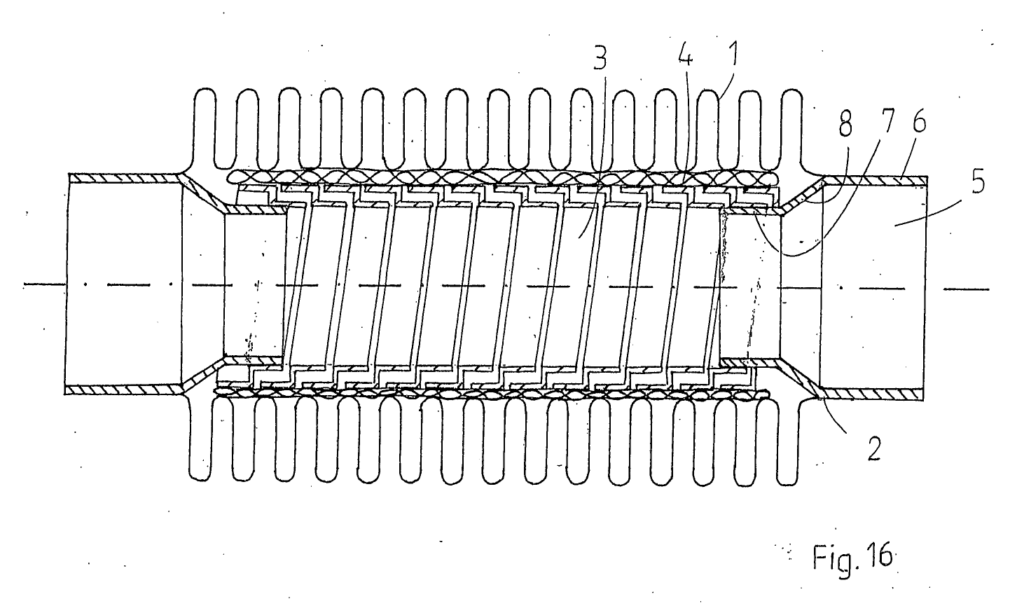

FIGS. 12 to 20 schematic section cuts through other embodiments for a flexible pipe element according to the invention.

FIG. 1 shows schematically the construction of an example for a flexible pipe element according to the invention. A metal bellows 1 with cylindrical ends 2 is provided with a coaxially inner, wound metal hose 3. Between the metal hose 3 and the metal bellows 1 there is a spacer 4, which is embodied as a knitted-material hose.

On the end of the flexible pipe element shown at the right in FIG. 1, the metal hose 3 is expanded, so that it comes to lie on the cylindrical end 2 of the metal bellows 1 and can be connected to this bellows at this position. In contrast, the end of the flexible pipe element shown at the left in FIG. 1 is provided with a separate adapter piece 5, which has an outer pipe section 6 and an inner pipe section 7, with both sections being connected by a conical section 8. The inner pipe section 7 of the adapter piece 5 is adapted in its outer diameter to the inner diameter of the metal hose 3, so that this can be set easily on the inner pipe section 7 and can be fixed at this position. In contrast, the outer pipe section 6 of the adapter piece 5 is adapted in its outer diameter to the inner diameter of the cylindrical end 2 of the metal bellows 1, so that this section can be pushed on its side onto the outer pipe section 6 and can be fixed in this position. Simultaneously, the spacer 4 can also be fixed on the adapter piece 5. The adapter piece 5 thus offers an uncomplicated and stable connection of the individual parts of the flexible pipe element, while it advantageously also leads the gas flow through the pipe part.

The metal hose 3 shown in FIG. 1 has a profile, which is shown in detail in FIG. 2.

The FIGS. 2 to 11 each show several wound sections or segments of various metal hoses 3 in section, wherein the extended position of the metal hose is shown on the left and the compressed position of the metal hose 3 is shown on the right in the figures.

The profile 9 shown in FIG. 2 comprises an inner axial section 10, an outer axial section 11, a radial section 12 connecting these axial sections, and also a profiled edge 13, 14 bent away from the axial sections 10, 11, wherein the profiled edges 13, 14 extend radially, but simultaneously have a smaller radial extent than the radial section 12.

The profile 9 shown in FIG. 3 is embodied similar to the profile 9 from FIG. 2; only the profiled edges 13 and 14 are bent back over the radial direction from the axial sections 10 and 11. As can be seen with reference to a comparison with FIG. 2, shortening of the movement possibilities of the metal hose 3 is barely produced, while the stability of the metal hose 3 would be slightly improved.

The profile 9 shown in FIG. 4 completely eliminates bent profiled edges; instead it comprises merely an outer axial section 11, an inner axial section 10, and a radial section 12 connecting these axial sections. The movement of the metal hose 3 is logically considerably increased, but at the price of a lack of protection from separation and significantly increased permeability for gases.

FIG. 5 shows a fourth variant of a profile 9, for which the bent profiled edges 13 and 14 are also bent at their ends into a hook shape in order to increase the stability of the metal hose 3 for angled movements. In comparison with FIG. 2, it can be seen clearly that this leads to loading, especially for the axial movement of the metal hose 3.

FIG. 6 shows a profile 9, which is embodied similar to the profile shown in FIG. 3, wherein, however, the profiled edges 13 and 14 are not bent back, but instead assume an open angle.

The common feature to the profiles shown in FIGS. 2 to 6 is that they have a radial section 12. At this point, it should be mentioned explicitly that this profiled section in no way has to run radially; instead other profiles of the connecting section are also conceivable.

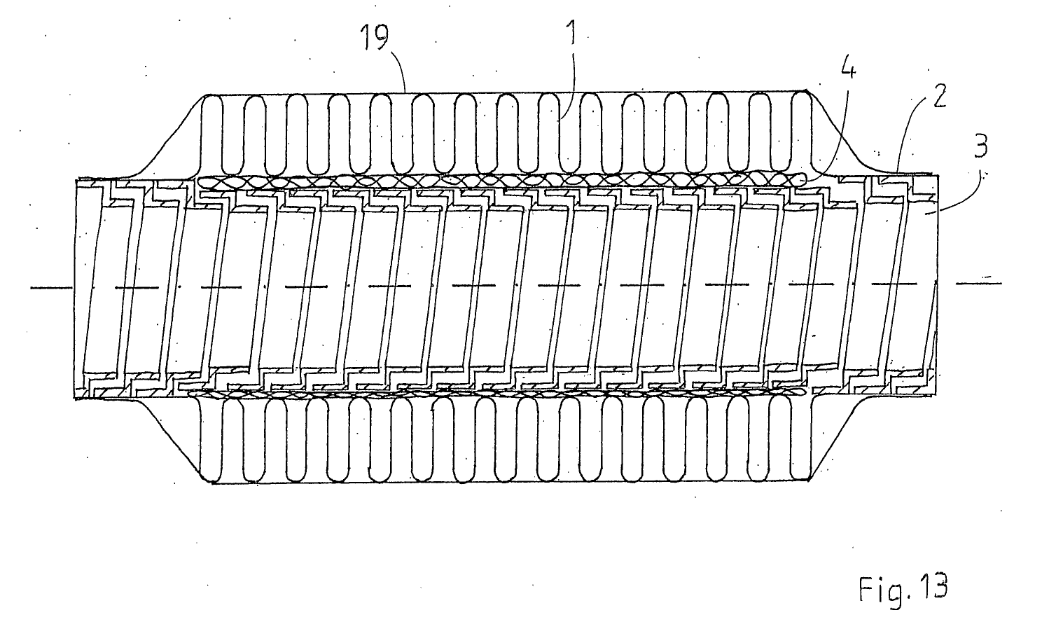

The profiles shown in FIGS. 7 to 10 differ from the profiles shown in FIGS. 2 to 6 in that an inwardly oriented wound section or such a segment is exchanged with an outwards oriented wound section or such a segment.

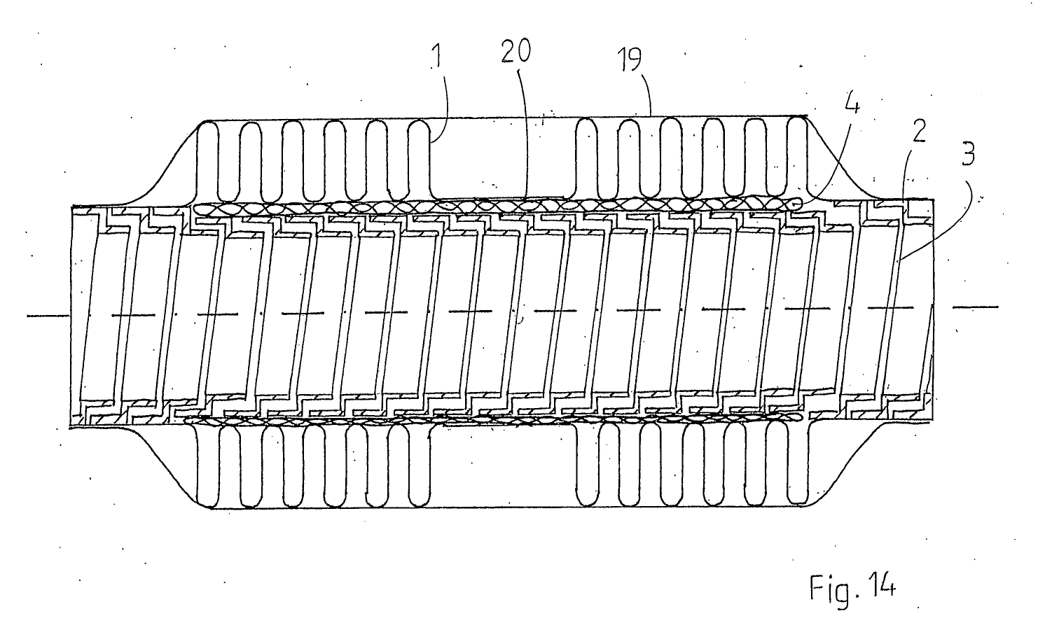

The profiles shown in FIGS. 7, 9, and 10 are embodied in the broadest sense with a U shape or roof shape or bracket-like shape, with a U base 15 and two bent-away U legs 16 connecting to this base. In FIG. 7, the U legs 16 are at an obtuse, open angle to the U base 15, while in FIG. 9 they form an acute, more closed angle with the U base 15, and in FIG. 10 they are at a right angle. Accordingly, the movement of the metal hose 3 shown in FIG. 10 is the greatest.

FIG. 8 shows a metal hose 3, which comprises two layers of flat metal bands 17 spaced apart in the radial direction.

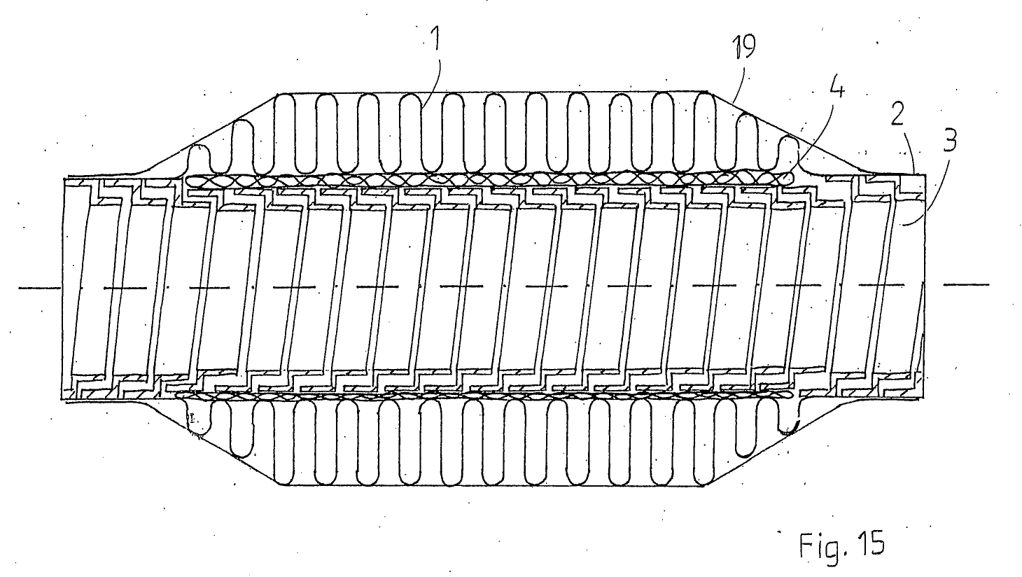

FIG. 11 finally shows profiles of a metal hose 3, which is embodied corresponding to the profiles in FIG. 4, but have two other bevels in order to reduce the permeability for the gas flow. Correspondingly, these profiles are comprised of an outer axial section 11, an inner axial section 10, an (additional) middle axial section 18, and two radial sections 12 connecting these axial sections 10, 11, 18.

All of the profiles 9 of the metal hose 3 shown in FIGS. 1 to 11 are based on the knowledge according to the invention that in the compressed position of the metal hose 3 shown at the right in FIGS. 2 to 11, a form-fit—thus a radial overlap of the profiled edges 13, 14—is not necessary as in the double-lock profile and by leaving out this feature, significantly increased movement of the metal hose 3 and thus an advantageously short construction of the entire pipe element can be achieved.

FIGS. 12 to 16 show different variants of a pipe element according to the invention, in which a metal hose 3 is used, which is wound from profiles like those shown in FIG. 4. A spacer 4 embodied as a knitted-material hose is positioned over a large surface area between this metal hose 3 and the metal bellows 1.

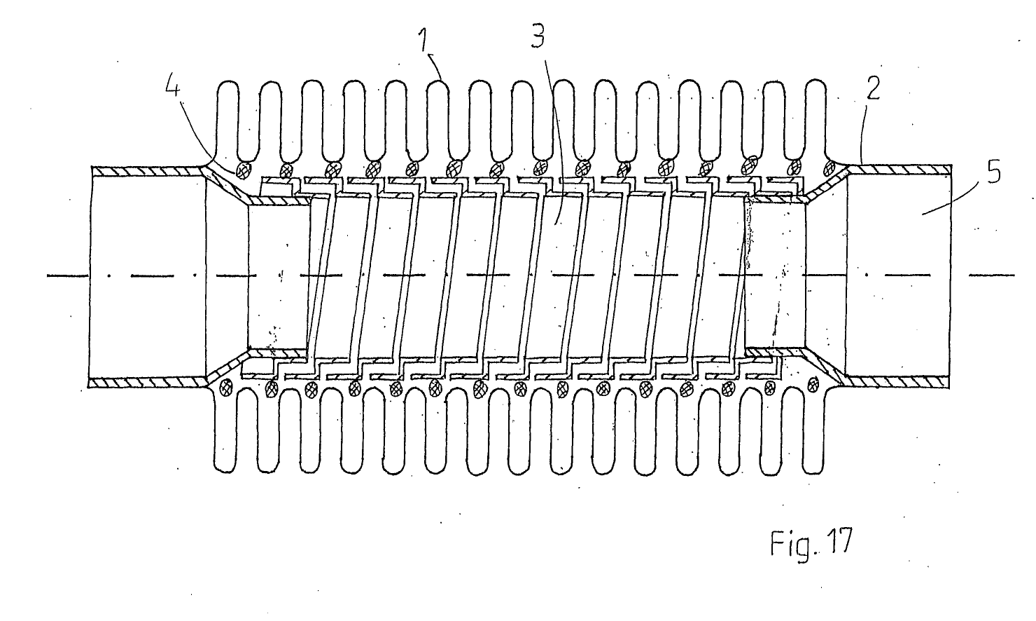

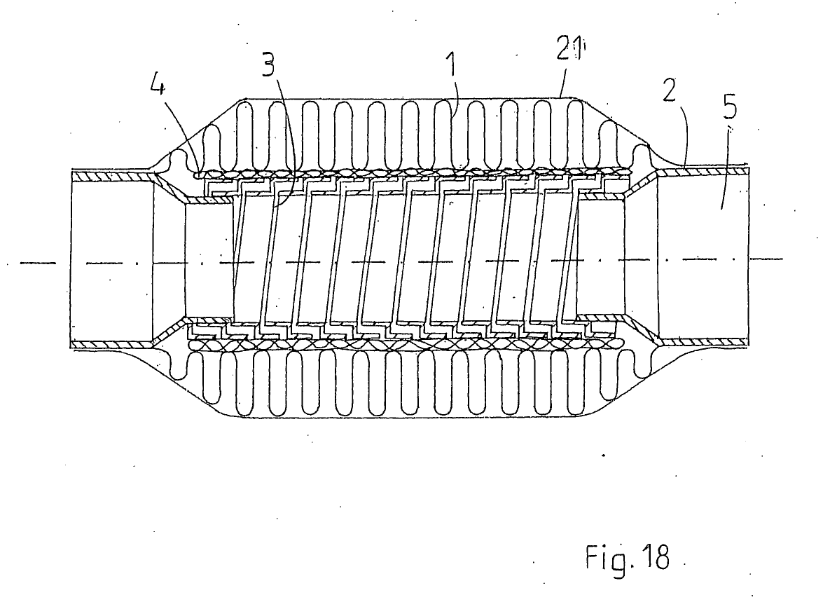

While FIG. 12 shows a simple metal bellows 1 with cylindrical ends 2, in which sit coaxially on the inside the metal hose 3 and the spacer 4 arranged in-between, wherein the metal hose 3 is fixed with a positive fit, for example, by means of a weld connection, directly to the cylindrical ends 2 of the metal bellows 1; FIG. 13 shows the same pipe element as FIG. 12, but with a knitted-material hose 19, which surrounds the metal bellows 1 on the outside and which is also attached with a positive-fit to the cylindrical ends 2 of the metal bellows 1. In FIG. 14, essentially the same pipe element is shown, but here a different metal bellows 1 is used: it has in the middle a non-corrugated, thus cylindrically formed region 20. Also, in FIG. 15 the metal bellows 1 is changed in comparison with FIGS. 12 and 13, that is, to the extent that its end corrugations are gradually decreased in their radial extent in order to create a softer transition for the surrounding knitted-material hose 19 and in this way to reduce the bending loads acting on the end corrugations due to the knitted-material hose 19. FIG. 16 again shows a pipe element according to FIG. 12, but in which the connection of the metal hose 3 to the cylindrical ends 2 of the metal bellows 1 is not direct, but instead, as already described with reference to FIG. 1, indirect by means of an adapter piece 5 at both ends.

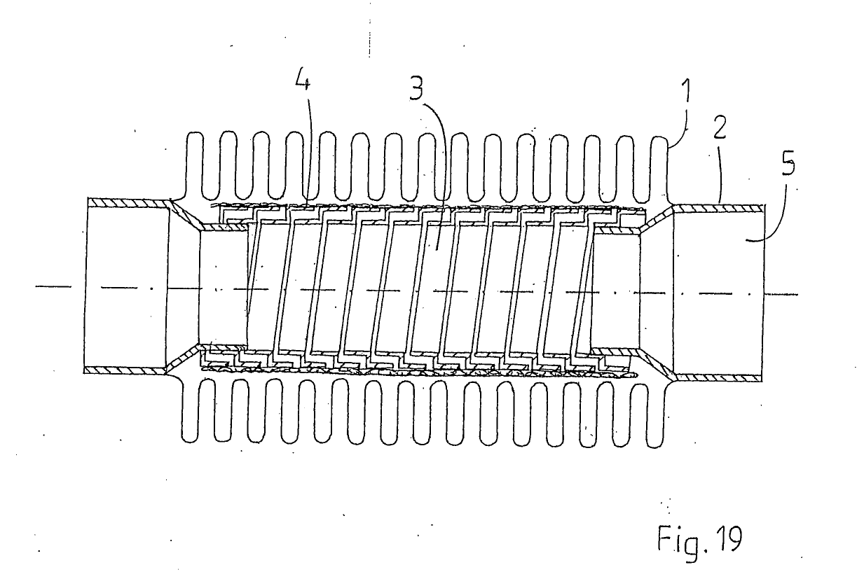

In FIG. 17, a pipe element is shown, which is provided in turn with two adapter pieces 5 for connecting the metal hose 3 to the cylindrical ends 2 of the metal bellows 1 and which corresponds essentially to the pipe element from FIG. 16. Here, however, the spacer 4 is no longer formed as a knitted-material hose, but instead it comprises a helical wound section between the metal bellows 1 and the metal hose 3.

Finally, FIGS. 18 to 20 show different variants of a pipe element according to the invention, in which in turn a metal hose 3 is used with profiles from FIG. 4.

In FIG. 18, the metal hose 3 sits in a metal bellows 1, whose end corrugations are reduced gradually in their radial extent and whose cylindrical ends 2 are connected indirectly to the metal hose 3 by means of an adapter piece 5. A spacer 4 arranged between the metal hose 3 and the metal bellows 1 comprises, in turn, a large area knitted-material hose. Now, in this embodiment another knitted-material hose 21 is positioned surrounding the metal bellows 1 on the outside.

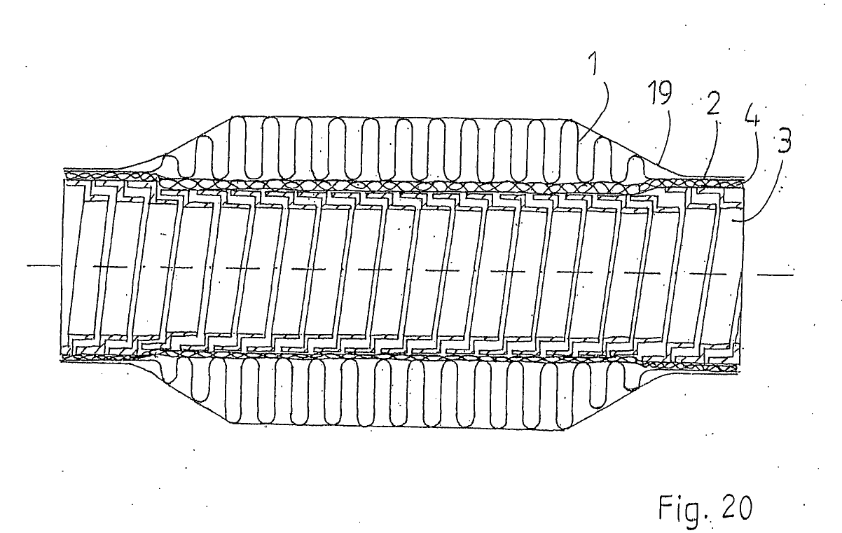

FIG. 19 shows a similar construction to FIG. 16, but here the spacer 4 is embodied as a significantly thinner knitted-material hose and accordingly does contact the outer surface of the metal hose 3 on one side, but does not contact the metal bellows 1 in the resting state.

Finally, FIG. 20 shows a pipe element according to the invention with metal bellows 1, metal hose 3, a spacer 4, which is positioned between these two elements and which is embodied as a knitted-material hose, and an outer knitted-material hose 19. The spacer 4 extends axially up to between the expanded ends of the metal hose 3 and the cylindrical ends 2 of the metal bellows 1.

1. Flexible pipe element for the exhaust-gas system of a motor vehicle, comprising a thread-like or annular corrugated metal bellows (1), with a metal hose (3), which is positioned coaxially within the metal bellows (1), which is wound in a thread-like manner or has annular segments, and having an external cross section that is smaller than an internal cross section of the metal bellows (1), and at least one spacer (4) arranged between the metal bellows (1) and the metal hose (3), wherein the metal hose (3) is formed with individual wound sections or individual annular segments that do not have a form-fit in a radial direction with an adjacent one of the wound sections or segments at least in a compressed position of the metal hose (3).

2. Flexible pipe element according to claim 1, wherein the spacer (4) is formed from a woven material, knitted material, mesh, or non-woven material.

3. Flexible pipe element according to claim 1, wherein the spacer (4) is fixed at least locally with a positive fit, form-fit, or non-positive fit on the metal bellows (1) and/or on the metal hose (3).

4. Flexible pipe element according to claim 1, wherein the spacer (4) is arranged to radially fix the metal hose (3) within the metal bellows (1).

5. Flexible pipe element according to claim 1, wherein the metal bellows (1) is surrounded on an outside thereof at least in sections by a mesh (19) and/or a knitted material.

6. Flexible pipe element according to claim 5, wherein the metal bellows (1) is surrounded on the outside at least in sections by a plurality of meshes (19) and/or knitted materials.

7. Flexible pipe element according to claim 1, wherein the metal hose (3) is formed from wound sections or segments with a profile (9), which comprises an inner axial section (10) and an outer axial section (11) and a section (12) connecting the inner and outer axial sections.

8. Flexible pipe element according to claim 1, wherein the metal hose (3) is formed from wound sections or segments with a profile (9), which comprises an inner axial section (10), a middle axial section (18), and an outer axial section (11), and two sections (12) connecting the axial sections.

9. Flexible pipe element according to claim 1, wherein the metal hose (3) is formed from wound sections or segments with a generally roof-shaped or bracket-shaped profile (15, 16), and axially adjacent ones of the profiles are oriented alternately radially inwardly and radially outwardly.

10. Flexible pipe element according to one claim 1, whrein the metal hose (3) is formed from flat wound sections (17) or segments.

11. Flexible pipe element according to claim 1, wherein the metal hose (3) is formed from wound sections or segments with a generally hook-shaped profile (9), and include bent profiled edges (13, 14) which do not mutually overlap at least in the compressed position of the metal hose (3) in the radial direction.

12. Flexible pipe element according to claim 11, wherein the profile (9) is formed from an inner axial section (10) and an outer axial section (11), a radial section (12) connecting the axial sections, and profiled edges (13, 14) bent away from the axial sections (10, 11), and the profiled edges (13, 14) have a smaller radial extent than the radial section (12).

13. Flexible pipe element according to claim 1, wherein the metal hose (3) is wound in the manner of a thread and has a ratio of extended to compressed lead greater than 1.39.

14. Flexible pipe element according to claim 1, wherein the metal hose (3) has a circular, flattened, or polygonal cross section.

15. Flexible pipe element according to claim 1, wherein the metal hose (3) is made from two or more bands or profiled sheets.

16. Flexible pipe element according to claim 15, wherein the metal hose (3) is made from at least two bands made from different materials.

17. Flexible pipe element according to claim 1, wherein an adapter piece (5) is provided on at least one of two ends of the pipe element, with an outer pipe section (6) for placement of a cylindrical end (2) of the metal bellows (1) and an inner pipe section (7) for placement or insertion of the metal hose (3).

18. Flexible pipe element according to claim 17, wherein the metal hose (3) is connected to the inner pipe section (7) of the adapter piece (5) with a positive fit, a form-fit, and/or a non-positive fit.

19. Flexible pipe element according to claim 1, wherein the metal hose (3) is connected directly to the metal bellows (1) on at least one of the two ends of the pipe element with a positive fit, a form-fit, and/or a non-positive fit.

20. Flexible pipe element according to claim 1, wherein the metal bellows (1) has one or more end corrugations with a reduced cross section.

21. Flexible pipe element according to claim 20, wherein at least one end corrugation of the metal bellows (1) with the reduced cross section is wider than other ones of the corrugations.

22. Flexible pipe element according to claim 1, wherein the metal bellows (1) has a non-corrugated pipe section (20) in a middle region.

23. Flexible pipe element according to claim 1, wherein the metal bellows (1) has a circular or flattened cross section.
